(19) United States
(12) Patent Application Publication
(10) Pub. No.: US 2007/0247540 A1
(43) Pub. Date: Oct. 25, 2007

(54) Camera and Image Display Apparatus Mounting the Same Camera

(75) Inventor: Takeyoshi Iguchi, Tokyo (JP)

Correspondence Address: CANTOR COLBURN, LLP, 55 GRIFFIN ROAD SOUTH, BLOOMFIELD, CT, 06002, US

(73) Assignee: KONICA MINOLTA HOLDINGS, INC., Tokyo (JP)

(21) Appl. No.: 11/662,508

(22) PCT Filed: Sep. 1, 2005
(86) PCT No.: PCT/JP05/15973

§ 371 Date: Mar. 9, 2007

(30) Foreign Application Priority Data
Sep. 14, 2004 (JP) 2004-266517

(51) Int. Cl. H04N 5/225

(52) U.S. Cl. 348/341; 348/E05.029

(57) ABSTRACT

To provide a camera, by which a photographer takes a photograph of him/herself, while checking his/her facial expression, and further checking whether his/her eye line is directed to a photographing lens of the camera, and to provide an image displaying apparatus including the same camera. The camera has a display means to display an image to be photographed, the display means is formed of a light emitting display element which becomes transparent when it does not display the image, which is mounted in front of the photographing lens.

### TECHNICAL FIELD

The present invention relates to a camera which carries a display means to immediately check the captured image of the photographer when the photographer captures the image him/herself, and to an image display apparatus incorporating the same camera.

### BACKGROUND ART

Generally when a photographer takes a picture, the photographer supports a camera in front of photographer's face, and views the subject through a view finder, or if the photographer uses a camera incorporating a liquid crystal display device, the photographer views the images displayed on the liquid crystal display, and checks the position of the subject or the picture composition of the total images.

However, in a portrait photography, there are cases in which the photographer wants to take a picture of him/herself, which is unexpectedly very difficult. During such self-image photography (hereinafter referred to as a self-photography), it is impossible to check his/her own image via the above-described finder or liquid crystal display.

To overcome this problem, proposed is a camera by which the photographer can check his/her image and change facial expressions, with, for example, a camera incorporating a mirror which is directed in the same direction as to the photographing lens (see Patent Document 1), or a camera incorporating a liquid crystal display means which is directed in the same direction as the photographing lens (see Patent Document 2).

However, when the photographer views his/her own image in the mirror or on the display as above, his/her visual line on a captured image is directed toward the mirror or the display, that is, the visual line is shifted away from the photographing lens. Concerning such captured image, since the visual line is an element to large dominating feature of facial expression, the visual line should be directed toward the photographing lens on the produced photograph, which is a major problem to be resolved.

[Patent Document 1] Unexamined Japanese Patent Application Publication No. 2002-82, 371, page 1.

[Patent Document 2] Unexamined Japanese Patent Application Publication No. 9-93, 468, pages 1-2.

### DISCLOSURE OF THE INVENTION

### Problems to be Solved by the Present Invention

The present invention was achieved in view of the above problem, and an object of the present invention is to provide a camera by which a photographer can check his/her facial image and can photograph his/her image whose visual line is directed toward the photographing lens, and an image display apparatus on which the same camera is mounted.

### MEANS TO SOLVE THE PROBLEMS

The above problem is attained by providing the structures described below.

Structure 1. A camera having a display means to display an image to be photographed on a screen,

wherein the display means is formed of a light emitting display element, when the display means does not function to display the image on the screen, the light emitting display element becomes transparent, and wherein the display means is mounted in front of the photographing lens.

Structure 2. The camera of Structure 1, wherein a non-image display area is provided on the screen of the display means.

Structure 3. The camera of Structure 1, further including a control means which controls an arbitrary area of the screen of the display means not to display the image.

Structure 4. A camera having a display means to display an image being photographed on a screen, comprising:

a display means formed of a light emitting display element, wherein when the display means does not function to display the image on the screen, the light emitting display element becomes transparent, and wherein the display means is mounted in front of a photographing lens;

a shutter release button which outputs a signal to start image photograph; and

a control means which allows a specific area of the screen of the display means not to display the image based on the signal outputted from the shutter release button.

Structure 5. A camera having a display means to display an image to be photographed on a screen, including:

the display means formed of a light emitting display element, wherein when the display means does not function to display the image on the screen, the light emitting display element becomes transparent;

an optical axis switching means which switches an optical axis toward which a photographing lens is aimed at the subject, by rotating a mirror provided in front of the photographing lens; and

a control means which controls the optical axis switching means to switch between the photographing operation while arranging the display means between the subject and the photographing lens, and the photographing operation while not arranging the display means between the subject and the photographing lens.

Structure 6. The camera of Structure 5, wherein the optical axis switching means rotates the mirror about the optical axis of the photographing lens.

Structure 7. The camera of Structure 5 or 6, wherein the shutter release buttons to output a signal to start photography are provided on a first surface of the exterior of the camera, and on a second surface which is the reverse of the first surface.

Structure 8. A camera having a display means to display an image being photographed on a screen, including:

a display means which is provided in front of the photographing lens, which includes a screen of a light emitting display element, and the screen becomes transparent when the display means does not function to display the image on the screen; and

a control means which obtains a third image by subtracting a second image from a first image, wherein the first image is photographed when the display means does not display the image, while the second image is an image of the display means which is transparent, and is previously obtained and stored.

Structure 9. An image displaying apparatus including the camera in any one of Structures 1 to 8.

### BRIEF DESCRIPTIONS OF THE DRAWINGS

FIG. 1 are schematic drawings showing the basic structure of a camera relating to the present embodiment.

FIG. 2 is a block diagram of the display means relating to the present embodiment.

FIG. 3 shows switching of the optical axis switching means relating to the present embodiment.

FIG. 4 is a block diagram relating to the present embodiment.

FIG. 5 is a flowchart of the self-photographing operation.

FIG. 6 are drawings to explain a non-image display area.

FIG. 7 show examples of the displayed image on image displaying apparatuses, relating to the present embodiment.

### EXPLANATION OF THE NUMBERS

10 photographing lens
20 image pickup element
30 optical axis switching means
31 mirror
32 rotation shaft
33 rotation means
40 display means
41 display surface
42,43 switching circuits
50 electric flash
60 shutter release button
70 protective glass cover
80 exterior surface
90 operation means
C control means
C1 EL control means

### PREFERRED EMBODIMENT OF THE INVENTION

The embodiments of the present invention will now be detailed while referring to the drawings.

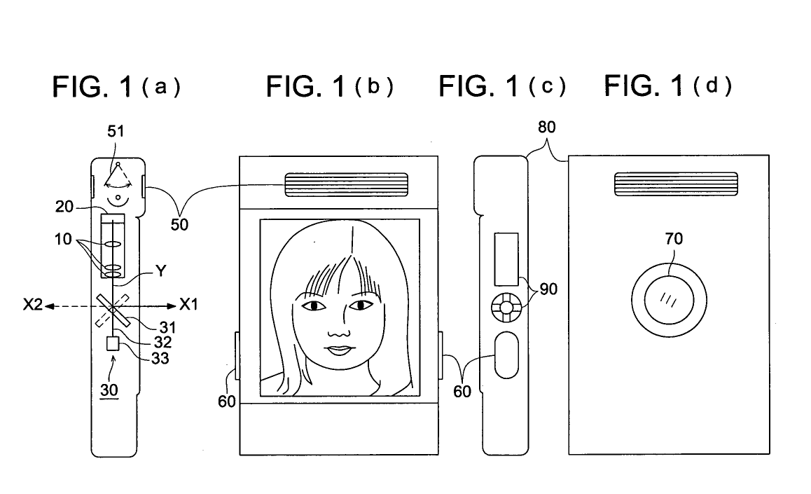

FIGS. 1(a)-1(d) are schematic drawings showing the basic structure of the camera relating to the present embodiment. The camera relating to the present embodiment is a digital type, which is structured of photographing lens 10, image pickup element 20, optical axis switching means 30, display means 40, electric flash 50, shutter release button 60, protective glass cover 70, exterior surface 80, operation means 90, and control means C.

FIG. 1(a) is a side view of the optical system of the camera relating to the present embodiment.

Light rays from a subject, existing in a direction to optical axis X1 or X2, are bent by optical axis switching means 30 and concentrated on image pickup element 20, having two dimensional light receiving surface, via optical axis Y of photographing lens 10.

Optical axis switching means 30 is structured of mirror 31, rotation shaft 32 mounted on mirror 31, and rotation means 33 to rotate rotation shaft 32. The center of rotation shaft 32 corresponds with optical axis Y of photographing lens 10. When rotation shaft 32 rotates 180°, the reflection surface of mirror 31 rotates 180° with rotation shaft 32, whereby the optical axis aiming at the subject is switched from optical axis X1 to optical axis X2, and vise versa. Rotation means 33 is controlled to rotate the rotation axis by 180° via control means C. A small motor or a solenoid can be used for rotation means 33. By the above-described structure, mirror 31 can be of a single reflecting surface, and the optical axis of photographing lens 10 is bent at a constant point on the reflecting surface of mirror 31. Further, as shown in FIG. 1(a), optical axes X1 and X2 form a single straight line, and optical axis Y and said single straight line are perpendicular to each other.

FIG. 1(b) is a front view (being the first surface) of the camera.

Well-known display means 40 is structured of display surface 41 represented by an organic EL (electro luminescence) screen, and switching circuits 42 and 43 arranged around the same. The organic EL as it is known in Japan, is known as OLED (organic light emitting diode) in The United States and Europe.

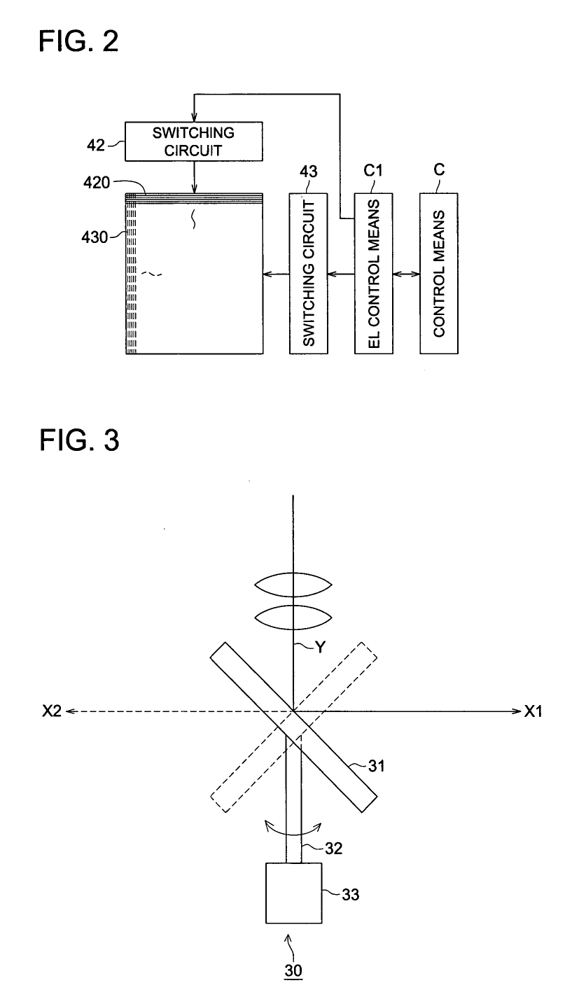

FIG. 2 is a block diagram of display means 40, employing a passive matrix method.

Switching circuits 42 and 43 output pulse signals to plural electrodes, based on image information sent from control means C, and predetermined positions on display surface 41 are controlled by EL control means C1 to become luminous, whereby said image information is displayed on display surface 41 as the subject image.

The size of display surface 41 of the camera relating to the present embodiment is 45×55 mm, approximately. Since the greater the size of display surface 41, the easier to view details of the displayed image, the maximum possible size of display surface 41 is preferably integrally mounted on the camera.

The thickness of organic layer relating to the light luminance screen is approximately 100 mm, which is transparent while in its non-luminance state. The organic layer is mounted between positive electrode 420, being a transparent conductive coating, and negative electrode 430. A single picture element of the organic layer is structured of three separate light luminous sections, namely B (blue), G (green) and R (red). The light luminous section of each color emits light rays when the appropriate electrical voltages are applied to the electrodes on both surfaces, and returns to transparency when no voltage is applied.

In FIG. 2, positive and negative electrodes 420 and 430 are mounted perpendicularly to each other, and switching circuits 42 and 43 apply the voltage on a predetermined position of display surface 41. The width of electrode is 70-100 μm, the pitch width is 100-150 μm, and the thickness is approximately 100 nm. The material for the transparent conductive coating used for these electrodes is well-known as ITO (which is an indium tin oxide), and IZO (which is an indium zinc oxide) is functional as another material for the conductive coating.

As should be clear from the above explanation, display surface 41 of display means 40 used in the present invention is formed of a transparent organic layer and transparent electrodes, which becomes transparent when no voltage is applied to the electrodes, that is, when the display surface 41 is not luminous.

Electric flash 50, mounted in the camera, has direction changing means 51 to change its flash direction based on an aiming direction of the camera, which is a well-known art.

FIG. 1(c) shows an opposite surface of the camera shown in FIG. 1(a), on which shutter release button 60 and operation means 90 are mounted.

Shutter release buttons 60 are provided on both surfaces of the camera as shown in FIG. 1(b). Because whichever optical axis X1 or X2 the photographer uses to photograph the subject, she/he can always push one of shutter release buttons 60 with the same finger, which is a convenient characteristic of the present invention. Further whether the photographer holds the camera with the left hand or the right hand, a given finger can push shutter release button 60 at the same relative position in each case. That is, the photographer can push shutter release button 60 in the same manner, while holding by the left hand or the right hand, which is an additional convenient effect of this embodiment.

Operation means 90 is used when the photographer sets various modes and settings to operate the camera, which is generally structured of a relatively small liquid crystal display and a push button.

FIG. 1(d) shows a rear surface (being a second surface) of the camera.

Protective glass cover 70, being a common part, covers an entrance provided on exterior surface 80, through which light rays enter from the subject on optical axis X2, and the light rays are further channeled to photographing lens 10 via switching means 30. This protective glass cover 70 prevents any foreign matter from entering the camera mechanism.

Exterior surface 80 is produced of appropriate materials, such as metals or resins.

FIG. 3 shows optical axis switching means 30.

As described above, optical axis Y of photographing lens 10 is bent 90° toward X1 or X2 by mirror 31, which serves as a surface mirror and is mounted on rotation shaft 32 at 45° against optical axis Y.

The rotational axis of rotating shaft 32 is the same as optical axis Y. Rotation means 33 is a driving unit which rotates rotation shaft 32 in a step of 180° via a control signal from control means C, which is a well-known technical means. Due to mirror 31, which rotates via rotation means 33, optical axis Y is always bent toward X1 or X2 at a given point of mirror 31.

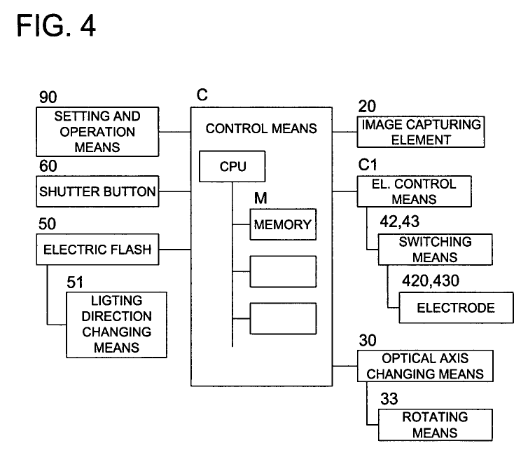

FIG. 4 is a block diagram showing the control steps of the camera.

Control means C is structured of a CPU, a memory, an operational unit, an input/output interface, a communication interface, and a driving circuit. The operations of each means of the camera are executed, via various programs stored in the memory. In addition, the blocks, which are not necessary for the explanation of the present invention, are not illustrated in FIG. 4.

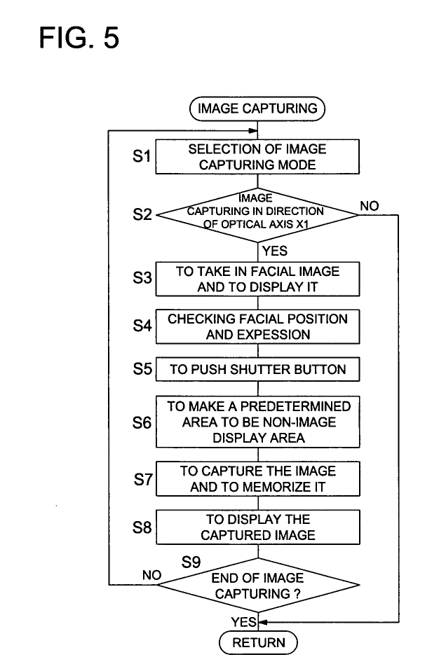

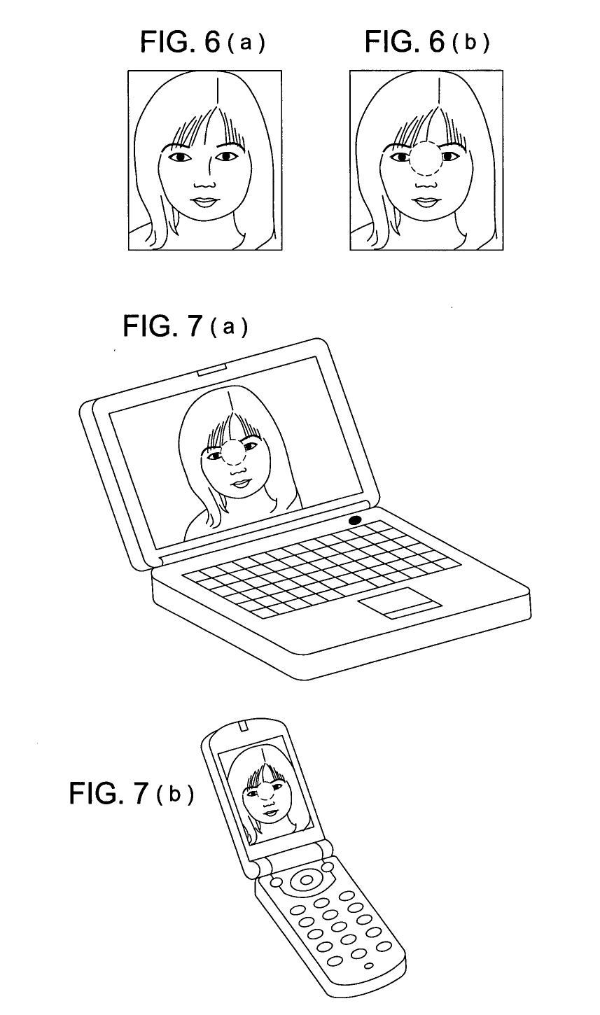

The flow of self photographing operation via the camera of the present invention will be detailed while referring to FIG. 5. Additionally, FIG. 6(b) shows the non-image display area of the display surface.

Firstly, via a photographing mode selecting means (step S1), a photographing mode is selected to photograph the subject existing in the direction of optical axis X1 (yes in step S2). When the photographer holds the camera to allow display surface 41 of display means 40 to face him/her, control means C allows whole display surface 41 not to display the image, being approximately transparent. Control means C obtains the facial image of the photographer, which exists in the direction of optical axis X1 as the subject, via image pickup element 20, and displays it on display surface 41 (step S3). Next, the whole or only a part of display surface 41 displaying the facial image is switched to the non-image displaying state, being the transparent display surface, and again the facial image is obtained by image pickup element 20, which is then displayed on display surface 41. The above-described switching action, between the displayed state and the non-displayed state of the facial image, is conducted within several dozen milli-seconds. Accordingly, when the photographer views display surface 41, the photographer views his/her facial image as if his/her facial image is always obtained and continuously changes.

The photographer views his/her face on display surface 41 to check its position or the facial expression (step S4), and when his/her face becomes desired one, the photographer pushes shutter release button 60 (step S5). Control means C detects the photograph start signal generated via shutter release button 60, and switches a specific area (shown by a dotted circle in FIG. 6(b)) of the facial image on display surface 41 to be the non-image display area (step S6). The non-image display area, is produced by stopping the application of voltage to the electrodes which allow the organic EL within the previously determined specific area to emit light. In addition, the specific area is determined via a field angle to capture the subject through photographing lens 10, and when the subject is to be photographed, the image area of display surface 41 is controlled not to be part of the field angle.

After the specific area is changed to the non-image display area, image pickup element 20 captures the image of the subject, stores it in memory M of control means C (step S7), and the captured image of the subject is displayed on display surface 41 of display means 40 (step S8).

The photographer evaluates the captured facial image displayed on display surface 41, to determine whether it is to be repeated (no of step S9) or to complete the photographing procedure (Yes of step S9).

Additionally, in the above explanation of step 3, whole display surface 41 was alternately switched between the image displaying state and the non-image displaying state to capture the image of the subject. However, a structure is also possible as shown in FIG. 6(b), by setting the area of display surface 41, which enters the field angle of photographing lens 10, to always be the non-image displaying area, photographing lens 10 can always aim the subject through display means 40 whose display surface 41 is in the transparent state. In this case, since a part of display surface 41 is the non-image display area as shown in FIG. 6(b), the image of the subject can be captured in the image displaying state.

In the present invention, display means 40 is used, which has display surface 41 incorporating the transparent conductive coats as the electrodes, as well as the organic EL layer provided between the electrodes. Further, the optical transmittance of display surface 41 used in the experiment, is 50-70%. In the camera of the present invention, such relatively low optical transmittance can be overcome by opening the diaphragm at one step, or by doubling the sensitivity of the image pickup device.

However, in the total surface of display surface 41, since the electrodes and other structuring elements, which are not optically even, exist, optical unevenness is superposed on the photograph with the image of the subject. The optical unevenness is so small that it can generally be ignored in the image of the subject. However, when a subject image with no density change and under-tinting is captured, the optical unevenness of display surface 41 is superposed on the image of the subject, which is noticeable in rare cases.

In order to overcome this problem, in the camera of the present invention, a uniformly white subject is captured under various conditions, that is, various diaphragm values of photographing lens 10, various exposure times (namely image capturing time), and various focal lengths. Due to this, uniform flat images are obtained as a white image, which are stored in a predetermined file of memory M. Next, after the image of the subject is captured in the usual way, the white image, which must closely approximate the photographic condition as the image of the subject, is selected among the previously stored white images. By subtracting the selected white image from the captured image, non-uniformity of the image of the subject can be cancelled out.

The above explanations concern the mode in which the subject exists in the direction of optical axis X1. On the other hand, when the mode, in which the subject exists in the direction of optical axis X2, is selected, control means C controls optical axis switching means 30 to rotate mirror 31 so that optical axis Y of photographing lens 10 directs to optical axis X2, after which mirror 31 stops at the appropriate position.

Since the procedure of photographing the subject in the direction of optical axis X2 and the operation of display means 40 are the same as those of common cameras on the market, the explanation is omitted.

Additionally, the above explanation concerns the camera which is used independently by the photographer. However, the effect of the present invention can also be obtained in an image displaying apparatus which incorporates the display means which becomes transparent under the non-image displaying state, as well as incorporates the functions of a camera. Said image displaying apparatus includes a cellular phone or a personal computer, both of which incorporate the camera to capture the photographer's facial image who faces the surface of the display means. FIGS. 7(a) and 7(b) show examples of displayed images on these image display apparatuses.

### INDUSTRIAL AVAILABLENESS

Based on the invention described in Structure 1, since the display means is provided between the photographing lens and the subject, a camera is realized in which both the visual line to view the display means and the visual line to view the photographing lens are equivalent. Accordingly, when the photographer captures his/her own facial image, the facial photograph is captured in which the visual line of the photographer accurately directs to the photographing lens.

Based on the invention described in Structure 2, since a transparent area is provided on the display surface of the display means which is included in the area (which is the image angle) in which the photographing lens is aimed at the subject, the image on the display means has no effect on the photographed image.

Based on the invention described in Structure 3, a camera can be realized in which the image display area of the display means is arbitrarily divided into image displaying area and transparent area.

Based on the invention described in Structure 4, a camera can be realized in which the display means is provided between the photographing lens and the subject, and the image area of the display means becomes transparent which is included in the area through which the photographing lens is aimed at the subject.

Based on the invention described in Structure 5, it is possible to realize a camera in which effective photographing operation is switched whether or not the display means is between the photographing lens and the subject.

Based on the invention described in Structure 6, by the switching means having no optical axial misalignment, it is possible to realize a camera in which effective photographing operation is switched whether or not the display means is between the photographing lens and the subject.

Based on the invention described in Structure 7, though the camera has two surfaces from which to view the subject, usability of the camera is not degraded, whereby the photographer can depress the shutter release button in the same way by both right or left hand by habit.

Based on the invention described in Structure 8, the display means is positioned between the photographing lens and the subject, whereby any uneven transmittance density of the transparent area of the display means can be digitally reduced from the image captured by the camera in which a specific part is changed to be transparent in the area of the displayed image which is obtained by the photographing lens while aiming at the subject.

Based on the invention described in Structure 9, an image display apparatus is realized with a camera in which the view line to view the display means agrees to the view line to view the photographic lens.

1. An image capturing device, comprising:
display section formed of a light emitting display element, being a screen to display a captured image, wherein when the display section does not function to display an image on the screen, the light emitting display element becomes transparent, and wherein the display section is mounted in front of a photographing lens.

2. The image capturing device of claim 1, wherein a non-image displaying area is provided on the screen of the display section.

3. The image capturing device of claim 1, further comprising a control section which controls an arbitrary area of the screen of the display section not to display the image.

4. The image capturing device of claim 1, further comprising:
a shutter release button which outputs a signal to start photograph; wherein
the control section allows a specific area of the screen of the display section not to display the image based on the signal outputted from the shutter release button.

5. The image capturing device of claim 1, further comprising:
an optical axis switching section which switches an optical axis via which a photographing lens is aimed at a subject, while rotationally driving a mirror provided in front of the photographing lens;
wherein the control section controls the optical axis switching section to switch an operation between a photographing operation while arranging the display section between the subject and the photographing lens, and a photographing operation while not arranging the display section between the subject and the photographing lens.

6. The image capturing device of claim 5, wherein the optical axis switching section rotationally drives the mirror while pivoting about the optical axis of the photographing lens.

7. The image capturing device of claim 4, wherein the shutter release buttons are provided on a first surface of an exterior of the image capturing device, and a second surface which is a reverse surface of the first surface.

8. The image capturing device of claim 3 wherein
the control section obtains a third image by subtracting a second image from a first image, wherein the first image is the image of the subject captured when the display section does not display the image of the subject, while the second image is an image displayed on the display section when the display section captures no image of the subject, and the second image is previously obtained and stored.

9. An image displaying apparatus including an image capturing device, comprising a display section formed of a light emitting display element, being a screen to display a captured image, wherein when the display means does not function to display an image on a screen, the screen of the light emitting display element becomes transparent, and wherein the display section is mounted in front of a photographing lens.
